(19) United States
(12) Patent Application Publication
(10) Pub. No.: US 2013/0337859 A1
(43) Pub. Date: Dec. 19, 2013

(54) RUGGEDIZED CASE OR SLEEVE FOR PROVIDING PUSH-TO-TALK (PTT) FUNCTIONS

(71) Applicants: Krishnakant M. Patel, Richardson, TX (US); Brahmananda R. Vempati, Dallas, TX (US); Anand Narayanan, Plano, TX (US); Gregory J. Morton, Plano, TX (US); Ravi Ayyasamy, Richardson, TX (US)

(72) Inventors: Krishnakant M. Patel, Richardson, TX (US); Brahmananda R. Vempati, Dallas, TX (US); Anand Narayanan, Plano, TX (US); Gregory J. Morton, Plano, TX (US); Ravi Ayyasamy, Richardson, TX (US)

(21) Appl. No.: 13/917,561

(22) Filed: Jun. 13, 2013

Related U.S. Application Data
(60) Provisional application No. 61/659,292, filed on Jun. 13, 2012.
(60) Provisional application No. 61/682,524, filed on Aug. 13, 2012.
(60) Provisional application No. 61/705,748, filed on Sep. 26, 2012.

(51) Int. Cl. H04W 4/10; H04B 1/38

(52) U.S. Cl. CPC H04W 4/10; H04B 1/3888
USPC 455/518; 455/575.8; 455/572

(57) ABSTRACT

A ruggedized case or sleeve for a handset, wherein the case or sleeve communicates with the handset to provide or support Push-to-Talk (PTT) functions on the handset, thereby converting the handset into a PTT-enabled handset, without requiring any hardware changes to the handset. The case or sleeve includes a dedicated PTT button for invoking the PTT functions on the handset.

### CROSS REFERENCE TO RELATED APPLICATIONS

This application claims the benefit under 35 U.S.C. Section 119(e) of the following co-pending and commonly-assigned patent applications:

U.S. Provisional Application Ser. No. 61/659,292, filed Jun. 13, 2012, by Krishnakant M. Patel, Brahmananda R. Vempati, Anand Narayanan, and Gregory J. Morton, entitled “PUSH-TO-TALK CASE OR SLEEVE FOR CONVERTING GENERIC DEVICES TO FUNCTION LIKE PURPOSE-BUILT PUSH-TO-TALK DEVICES,” attorneys' docket number 154.47-US-P1;

U.S. Provisional Application Ser. No. 61/682,524, filed Aug. 13, 2012, by Krishnakant M. Patel, Brahmananda R. Vempati, Anand Narayanan, and Gregory J. Morton, entitled “RUGGEDIZED PUSH-TO-TALK (PTT) CASE,” attorneys' docket number 154.47-US-P2; and

U.S. Provisional Application Ser. No. 61/705,748, filed Sep. 26, 2012, by Krishnakant M. Patel, Brahmananda R. Vempati, Anand Narayanan, Gregory J. Morton, and Ravi Ayyasamy, entitled “PUSH-TO-TALK CASE OR SLEEVE FOR CONVERTING GENERIC DEVICES TO FUNCTION LIKE PURPOSE-BUILT PUSH-TO-TALK DEVICES,” attorneys' docket number 154.47-US-P3;

which applications are incorporated by reference herein.

This application is related to the following commonly-assigned patent applications:

U.S. Utility application Ser. No. 10/515,556, filed Nov. 23, 2004, by Gorachand Kundu, Ravi Ayyasamy and Krishnakant Patel, entitled “DISPATCH SERVICE ARCHITECTURE FRAMEWORK,” attorney docket number G&C 154.4-US-WO, now U.S. Pat. No. 7,787,896, issued Aug. 31, 2010, which application claims the benefit under 35 U.S.C. Section 365 of P.C.T. International Application Serial Number PCT/US03/16386 (154.4-WO-U1), which application claims the benefit under 35 U.S.C. Section 119(e) of U.S. Provisional Application Ser. Nos. 60/382,981 (154.3-US-P1), 60/383,179 (154.4-US-P1) and 60/407,168 (154.5-US-P1);

U.S. Utility application Ser. No. 10/564,903, filed Jan. 17, 2006, by F. Craig Farrill, Bruce D. Lawler and Krishnakant M. Patel, entitled “PREMIUM VOICE SERVICES FOR WIRELESS COMMUNICATIONS SYSTEMS,” attorney docket number G&C 154.7-US-WO, which application claims the benefit under 35 U.S.C. Section 365 of P.C.T. International Application Serial Number PCT/US04/23038 (154.7-WO-U1), which application claims the benefit under 35 U.S.C. Section 119(e) of U.S. Provisional Application Ser. Nos. 60/488,638 (154.7-US-P1), 60/492,650 (154.8-US-P1) and 60/576,094 (154.14-US-P1) and which application is a continuation-in-part and claims the benefit under 35 U.S.C. Sections 119, 120 and/or 365 of P.C.T. International Application Serial Number PCT/US03/16386 (154.4-WO-U1);

U.S. Utility application Ser. No. 11/126,587, filed May 11, 2005, by Ravi Ayyasamy and Krishnakant M. Patel, entitled “ARCHITECTURE, CLIENT SPECIFICATION AND APPLICATION PROGRAMMING INTERFACE (API) FOR SUPPORTING ADVANCED VOICE SERVICES (AVS) INCLUDING PUSH TO TALK ON WIRELESS HANDSETS AND NETWORKS,” attorney docket number 154.9-US-U1, now U.S. Pat. No. 7,738,892, issued Jun. 15, 2010, which application claims the benefit under 35 U.S.C. Section 119(e) of U.S. Provisional Application Ser. Nos. 60/569,953 (154.9-US-P1) and 60/579,309 (154.15-US-P1), and which application is a continuation-in-part and claims the benefit under 35 U.S.C. Sections 119, 120 and/or 365 of U.S. Utility Application Ser. No. 10/515,556 (154.4-US-WO) and P.C.T. International Application Serial Number PCT/US04/23038 (154.7-WO-U1);

U.S. Utility application Ser. No. 11/129,268, filed May 13, 2005, by Krishnakant M. Patel, Gorachand Kundu, Ravi Ayyasamy and Basem Ardah, entitled “ROAMING GATEWAY FOR SUPPORT OF ADVANCED VOICE SERVICES WHILE ROAMING IN WIRELESS COMMUNICATIONS SYSTEMS,” attorney docket number 154.10-US-U1, now U.S. Pat. No. 7,403,775, issued Jul. 22, 2008, which application claims the benefit under 35 U.S.C. Section 119(e) of U.S. Provisional Application Ser. No. 60/571,075 (154.10-US-P1), and which application is a continuation-in-part and claims the benefit under 35 U.S.C. Sections 119, 120 and/or 365 of U.S. Utility application Ser. No. 10/515,556 (154.4-US-WO) and P.C.T. International Application Serial Number PCT/US04/23038 (154.7-WO-U1);

U.S. Utility application Ser. No. 11/134,883, filed May 23, 2005, by Krishnakant Patel, Vyankatesh V. Shanbhag, Ravi Ayyasamy, Stephen R. Horton and Shan-Jen Chiou, entitled “ADVANCED VOICE SERVICES ARCHITECTURE FRAMEWORK,” attorney docket number 154.11-US-U1, now U.S. Pat. No. 7,764,950, issued Jul. 27, 2010, which application claims the benefit under 35 U.S.C. Section 119(e) of U.S. Provisional Application Ser. Nos. 60/573,059 (154.11-US-P1) and 60/576,092 (154.12-US-P1), and which application is a continuation-in-part and claims the benefit under 35 U.S.C. Sections 119, 120 and/or 365 of U.S. Utility application Ser. No. 10/515,556 (154.4-US-WO), P.C.T. International Application Serial Number PCT/US04/23038 (154.7-WO-U1), U.S. Utility application Ser. No. 11/126,587 (154.9-US-U1), and U.S. Utility application Ser. No. 11/129,268 (154.10-US-U1);

U.S. Utility application Ser. No. 11/136,233, filed May 24, 2005, by Krishnakant M. Patel, Vyankatesh Vasant Shanbhag, and Anand Narayanan, entitled “SUBSCRIBER IDENTITY MODULE (SIM) ENABLING ADVANCED VOICE SERVICES (AVS) INCLUDING PUSH-TO-TALK, PUSH-TO-CONFERENCE AND PUSH-TO-MESSAGE ON WIRELESS HANDSETS AND NETWORKS,” attorney docket number 154.13-US-U1, now U.S. Pat. No. 7,738,896, issued Jun. 15, 2010, which application claims the benefit under 35 U.S.C. Section 119(e) of U.S. Provisional Application Ser. No. 60/573,780 (154.13-US-P1), and which application is a continuation-in-part and claims the benefit under 35 U.S.C. Sections 119, 120 and/or 365 of U.S. Utility application Ser. No. 10/515,556 (154.4-US-WO), P.C.T. International Application Serial Number PCT/US04/23038 (154.7-WO-U1), U.S. Utility application Ser. No. 11/126,587 (154.9-US-U1), and U.S. Utility application Ser. No. 11/134,883 (154.11-US-U1);

U.S. Utility application Ser. No. 11/158,527, filed Jun. 22, 2005, by F. Craig Farrill, entitled “PRESS-TO-CONNECT FOR WIRELESS COMMUNICATIONS SYSTEMS,” attorney docket number 154.16-US-U1, now U.S. Pat. No. 7,529,557, issued May 5, 2009, which application claims the benefit under 35 U.S.C. Section 119(e) of U.S. Provisional Application Ser. No. 60/581,954 (154.16-US-P1), and which application is a continuation-in-part and claims the benefit under 35 U.S.C. Sections 119, 120 and/or 365 of U.S. Utility application Ser. No. 10/515,556 (154.4-US-WO) and P.C.T. International Application Ser. No. PCT/US04/23038 (154.7-WO-U1);

U.S. Utility application Ser. No. 11/183,516, filed Jul. 18, 2005, by Deepankar Biswaas, entitled “VIRTUAL PUSH TO TALK (PoC) AND PUSH TO SHARE (PTS) FOR WIRELESS COMMUNICATIONS SYSTEMS,” attorney docket number 154.17-US-U1, which application claims the benefit under 35 U.S.C. Section 119(e) of U.S. Provisional Application Ser. No. 60/588,464 (154.17-US-P1);

U.S. Utility application Ser. No. 11/356,775, filed Feb. 17, 2006, by Krishnakant M. Patel, Bruce D. Lawler, Giridhar K. Boray, and Brahmananda R. Vempati, entitled “ENHANCED FEATURES IN AN ADVANCED VOICE SERVICES (AVS) FRAMEWORK FOR WIRELESS COMMUNICATIONS SYSTEMS,” attorney docket number 154.18-US-U1, now U.S. Pat. No. 7,813,722, issued Oct. 12, 2010, which application claims the benefit under 35 U.S.C. Section 119(e) of U.S. Provisional Application Ser. No. 60/654,271(154.18-US-P1);

P.C.T. International Application Serial Number PCT/US2006/011628, filed Mar. 30, 2006, by Krishnakant M. Patel, Gorachand Kundu, Sameer Dharangaonkar, Giridhar K. Boray, and Deepankar Biswas, entitled “TECHNIQUE FOR IMPLEMENTING ADVANCED VOICE SERVICES USING AN UNSTRUCTURED SUPPLEMENTARY SERVICE DATA (USSD) INTERFACE,” attorney docket number 154.19-WO-U1, which application claims the benefit under 35 U.S.C. Section 119(e) of U.S. Provisional Application Ser. No. 60/666,424 (154.19-US-P1);

U.S. Utility application Ser. No. 11/462,332, filed Aug. 3, 2006, by Deepankar Biswas, Krishnakant M. Patel, Giridhar K. Boray, and Gorachand Kundu, entitled “ARCHITECTURE AND IMPLEMENTATION OF CLOSED USER GROUPS AND LIMITING MOBILITY IN WIRELESS NETWORKS,” attorney docket number 154.20-US-U1, now U.S. Pat. No. 7,689,238, issued Mar. 30, 2010, which application claims the benefit under 35 U.S.C. Section 119(e) of U.S. Provisional Application Ser. No. 60/705,115 (154.20-US-P1);

U.S. Utility application Ser. No. 11/463,186 , filed Aug. 8, 2006, by Ravi Ayyasamy and Krishnakant M. Patel, entitled “BREW PLATFORM ENABLING ADVANCED VOICE SERVICES (AVS) INCLUDING PUSH-TO-TALK, PUSH-TO-CONFERENCE AND PUSH-TO-MESSAGE ON WIRELESS HANDSETS AND NETWORKS,” attorney docket number 154.21-US-U1, now U.S. Pat. No. 8,036,692, issued Oct. 11, 2011, which application claims the benefit under 35 U.S.C. Section 119(e) of U.S. Provisional Application Ser. No. 60/706,265 (154.21-US-P1);

U.S. Utility application Ser. No. 11/567,098, filed Dec. 5, 2006, by Ravi Ayyasamy, Bruce D. Lawler, Krishnakant M. Patel, Vyankatesh V. Shanbhag, Brahmananda R. Vempati, and Ravi Shankar Kumar, entitled “INSTANT MESSAGING INTERWORKING IN AN ADVANCED VOICE SERVICES (AVS) FRAMEWORK FOR WIRELESS COMMUNICATIONS SYSTEMS,” attorney docket number 154.23-US-U1, which application claims the benefit under 35 U.S.C. Section 119(e) of U.S. Provisional Application Ser. No. 60/742,250 (154.23-US-P1);

U.S. Utility application Ser. No. 11/740,805, filed Apr. 26, 2007, by Krishnakant M. Patel, Giridhar K. Boray, Ravi Ayyasamy, and Gorachand Kundu, entitled “ADVANCED FEATURES ON A REAL-TIME EXCHANGE SYSTEM,” attorney docket number 154.26-US-U1, now U.S. Pat. No. 7,853,279, issued Dec. 14, 2010, which application claims the benefit under 35 U.S.C. Section 119(e) of U.S. Provisional Application Ser. No. 60/795,090 (154.26-US-P1);

U.S. Utility application Ser. No. 11/891,127, filed Aug. 9, 2007, by Krishnakant M. Patel, Deepankar Biswas, Sameer P. Dharangaonkar and Terakanambi Nanjanayaka Raja, entitled “EMERGENCY GROUP CALLING ACROSS MULTIPLE WIRELESS NETWORKS,” attorney docket number 154.27-US-U1, which application claims the benefit under 35 U.S.C. Section 119(e) of U.S. Provisional Application Ser. No. 60/836,521 (154.27-US-P1);

U.S. Utility application Ser. No. 12/259,102, filed on Oct. 27, 2008, by Krishnakant M. Patel, Gorachand Kundu, Ravi Ayyasamy, Bruce D. Lawler, Ravi Shankar Kumar, Harisha Mahabaleshwara Negalaguli, Ahmad Basem Ardah, Pratap Chandana, Shan-Jen Chiou, Arun Velayudhan, and Ramu Kandula, entitled “CONNECTED PORTFOLIO SERVICES FOR A WIRELESS COMMUNICATIONS NETWORK,” attorneys' docket number 154.32-US-U1, which application claims the benefit under 35 U.S.C. Section 119(e) of U.S. Provisional Application Ser. Nos. 60/982,650 (154.32-US-P1) and 61/023,042 (154.32-US-P2);

U.S. Utility application Ser. No. 12/359,861, filed on Jan. 26, 2009, by Bruce D. Lawler, Krishnakant M. Patel, and Brahmananda R. Vempati, entitled “CONVERGED MOBILE-WEB COMMUNICATIONS SOLUTION,” attorneys' docket number 154.33-US-U1, which application claims the benefit under 35 U.S.C. Section 119(e) of U.S. Provisional Application Ser. No. 61/023,332 (154.33-US-P1);

U.S. Utility application Ser. No. 12/582,601, filed Oct. 20, 2009, by Krishnakant M. Patel, Ravi Ayyasamy, Gorachand Kundu, Basem A. Ardah, Anand Narayanan, Brahmananda R. Vempati, and Pratap Chandana, entitled “HYBRID PUSH-TO-TALK FOR MOBILE PHONE NETWORKS,” attorney docket number 154.36-US-U1, which application claims the benefit under 35 U.S.C. Section 119(e) of U.S. Provisional Application Ser. No. 61/106,689 (154.36-US-P1);

U.S. Utility application Ser. No. 12/781,566, filed on May 17, 2010, by Bruce D. Lawler, Krishnakant M. Patel, Ravi Ayyasamy, Harisha Mahabaleshwara Negalaguli, Binu Kaiparambil, Shiva K. K. Cheedella, Brahmananda R. Vempati, and Ravi Shankar Kumar, entitled “CONVERGED MOBILE-WEB COMMUNICATIONS SOLUTION,” attorneys' docket number 154.38-US-I1, which application is a continuation-in-part and claims the benefit under 35 U.S.C. Sections 119, 120 and/or 365 of U.S. Utility application Ser. No. 12/582,601 (154.36-US-U1);

U.S. Utility application Ser. No. 12/750,175, filed on Mar. 30, 2010, by Bruce D. Lawler, Krishnakant M. Patel, Ravi Ayyasamy, Harisha Mahabaleshwara Negalaguli, Basem A. Ardah, Gorachund Kundu, Ramu Kandula, Brahmananda R. Vempati, Ravi Shankar Kumar, Chetal M. Patel, and Shiva K. K. Cheedella, entitled “ENHANCED GROUP CALLING FEATURES FOR CONNECTED PORTFOLIO SERVICES IN A WIRELESS COMMUNICATIONS NETWORK,” attorneys' docket number 154.39-US-U1, which application claims the benefit under 35 U.S.C. Section 119(e) of U.S. Provisional Application Ser. Nos. 61/164,754 (154.39-US-P1) and 61/172,129 (154.39-US-P2);

U.S. Utility application Ser. No. 12/961,419, filed Dec. 6, 2010, by Ravi Ayyasamy, Bruce D. Lawler, Brahmananda R. Vempati, Gorachand Kundu and Krishnakant M. Patel, entitled “COMMUNITY GROUP CLIENT AND COMMUNITY AUTO DISCOVERY SOLUTIONS IN A WIRELESS COMMUNICATIONS NETWORK,” attorneys' docket number 154.40-US-U1, which application claims the benefit under 35 U.S.C. Section 119(e) of U.S. Provisional Application Ser. No. 61/266,896 (154.40-US-P1);

U.S. Utility application Ser. No. 13/039,635, filed on Mar. 3, 2011, by Narasimha Raju Nagubhai, Ravi Shankar Kumar, Krishnakant M. Patel, and Ravi Ayyasamy, entitled “PREPAID BILLING SOLUTIONS FOR PUSH-TO-TALK IN A WIRELESS COMMUNICATIONS NETWORK,” attorneys' docket number 154.41-US-U1, now U.S. Pat. No. 8,369,829, issued Feb. 5, 2013, which application claims the benefit under 35 U.S.C. Section 119(e) of U.S. Provisional Application Ser. No. 61/310,245 (154.41-US-P1);

U.S. Utility application Ser. No. 13/093,542, filed Apr. 25, 2011, by Brahmananda R. Vempati, Krishnakant M. Patel, Pratap Chandana, Anand Narayanan, Ravi Ayyasamy, Bruce D. Lawler, Basem A. Ardah, Ramu Kandula, Gorachand Kundu, Ravi Shankar Kumar, and Bibhudatta Biswal, and entitled “PREDICTIVE WAKEUP FOR PUSH-TO-TALK-OVER-CELLULAR (PoC) CALL SETUP OPTIMIZATIONS,” attorneys' docket number 154.42-US-U1, which application claims the benefit under 35 U.S.C. Section 119(e) of U.S. Provisional Application Ser. No. 61/347,217 (154.42-US-P1);

U.S. Utility application Ser. No. 13/710,683, filed Dec. 11, 2012, by Ravi Ayyasamy, Gorachand Kundu, Krishnakant M. Patel, Brahmananda R. Vempati, Harisha Mahabaleshwara Negalaguli, Shiva Koteshwara Kiran Cheedella, Basem A. Ardah, Ravi Shankar Kumar, Ramu Kandula, Arun Velayudhan, Shibu Narendranathan, Bharatram Setti, Anand Narayanan, and Pratap Chandana, entitled “PUSH-TO-TALK-OVER-CELLULAR (PoC),” attorneys' docket number 154.43-US-U1, which application claims the benefit under 35 U.S.C. Section 119(e) of U.S. Provisional Application Ser. No. 61/570,694 (154.43-US-P2); and

U.S. Utility application Ser. No. 13/757,520, filed Feb. 1, 2013, by Krishnakant M. Patel, Harisha Mahabaleshwara Negalaguli, Brahmananda R. Vempati, Shiva Koteshwara Kiran Cheedella, Arun Velayudhan, Raajeev Kuppa, Gorachand Kundu, Ravi Ganesh Ramamoorthy, Ramu Kandula, Ravi Ayyasamy, and Ravi Shankar Kumar, entitled “WiFi INTERWORKING SOLUTIONS FOR PUSH-TO-TALK-OVER-CELLULAR (PoC),” attorneys' docket number 154.48-US-U1, which application claims the benefit under 35 U.S.C. Section 119(e) of U.S. Provisional Application Ser. No. 61/593,485 (154.48-US-P1);

all of which applications are incorporated by reference herein.

### BACKGROUND OF THE INVENTION

1. Field of the Invention

This invention relates in general to mobile phone networks, and more specifically, to a ruggedized case or sleeve for a handset that provides and supports Push-to-Talk (PTT) functions on the handset.

2. Description of Related Art

Advanced Voice Services (AVS), also known as Advanced Group Services (AGS), which includes such functions as two-way half-duplex voice calls within a group, also known as Push-to-Talk (PTT), Push-to-talk-over-Cellular (PoC), or Press-to-Talk (P2T), as well as other AVS functions, such as Push-to-Conference (P2C) or Instant Conferencing, Push-to-Message (P2M), etc., are described in the co-pending and commonly-assigned patent applications cross-referenced above and incorporated by reference herein. These AVS functions have enormous revenue earnings potential for wireless communications systems, such as cellular phone networks, wireless data networks, and other wireless communications systems.

Nonetheless, there is a need in the art for improvements to the methods and systems for delivering the advanced voice services, such as PTT, that comply with both existing and emerging wireless standards and yet provide superior user experiences. The present invention satisfies the need for a superior user experience by providing a ruggedized case or sleeve for a handset that provides and supports PTT functions on the handset.

### SUMMARY OF THE INVENTION

To overcome the limitations in the prior art described above, and to overcome other limitations that will become apparent upon reading and understanding the present specification, the present invention discloses a PTT-enabled ruggedized case or sleeve for enclosing a handset, wherein the case or sleeve communicates with the handset to provide or support PTT functions on the handset, thereby converting the handset into a PTT-enabled handset, without requiring any hardware changes to the handset. The case or sleeve includes a dedicated PTT button for invoking the PTT functions on the handset.

### BRIEF DESCRIPTION OF THE DRAWINGS

Referring now to the drawings in which like reference numbers represent corresponding parts throughout:

FIG. 1 is a block diagram that illustrates an exemplary embodiment of a wireless communications network according to a preferred embodiment of the present invention.

FIG. 2 illustrates the high-level functional components and their interfaces in a handset according to one embodiment of the present invention.

FIG. 3A is a front view of a PTT-enabled ruggedized case, according to a first embodiment of the present invention.

FIG. 3B is a rear view of the PTT-enabled ruggedized case, according to the first embodiment of the present invention.

FIGS. 4A and 4B are front and rear views of an alternative PTT-enabled ruggedized case, according to a second embodiment of the present invention.

FIG. 5 is a front view of another alternative PTT-enabled ruggedized case, according to a third embodiment of the present invention.

FIG. 6 shows various views of an alternative PTT-enabled ruggedized case, according to a fourth embodiment of the present invention.

FIG. 7 illustrates how a PTT-enabled ruggedized case may facilitate Direct Mode Communications, such as Family Radio Service (FRS), General Mobile Radio Service (GMRS), or Terrestrial Trunked Radio (TETRA), according to one embodiment of the present invention.

FIG. 8 illustrates an exemplary schematic of the circuitry embedded in a PTT-enabled ruggedized case, according to one embodiment of the present invention.

### DETAILED DESCRIPTION OF THE INVENTION

In the following description of the preferred embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

1 Overview

PTT handsets are typically used in harsh environments and have to overcome many physical challenges. With the advent of downloadable PoC clients, smartphones can be enabled to function as PTT handsets. However, smartphones are typically neither ruggedized nor designed with PTT specific requirements in mind.

The present invention discloses a PTT-enabled ruggedized case or sleeve for a smartphone that incorporates many PTT features that are normally part of a purpose-built PTT handset. Specifically, the PTT-enabled ruggedized case of the present invention encloses a handset and communicates with the handset to provide or support PTT functions on the handset, thereby converting the handset into a PTT-enabled handset, without requiring any hardware changes to the handset. The PTT-enabled ruggedized case or sleeve may be provided to an end-user by a network operator or an after-market vendor.

Key requirements for the PTT-enabled ruggedized case of the present invention include the following:
Ruggedization—In addition to handling physical abuse, such as being dropped from heights, a PTT handset is typically operated in harsh conditions where humidity, rain, heat and dust are customary.
Dedicated loud speaker—While today's phones typically include built-in speakers, the strength of audio volume from these speakers does not meet the requirements of operating in noisy conditions.
Dedicated PTT Button—Purpose-built PTT handsets typically include a dedicated PTT button. Generic phones lack such a dedicated button and assigning a soft button to PTT detracts from a good user experience.
Dedicated Emergency button—PTT handsets sold in certain vertical markets include an emergency button, pressing which signals specified members of a distress situation, reports the location and possibly activates the microphone for monitoring by a console position.
Durable dock connector—PTT handsets are often carried in vehicles that cause vibrations. A flimsy dock connector (used for charging or for use with other accessories), which are prevalent in generic phones, can easily damage in these conditions.
Direct Mode Communications capability—A device-to-device capability operating in direct mode communications where two devices interact with each other without requiring an intervening network infrastructure. This capability is useful as a backup in the event of emergencies, such as disaster situations, or simply when the user is outside the network coverage area.
Thumb-wheel for Channel Change—A conveniently located thumb-wheel allows the user to change channels on the PTT handset.
Additional Battery—Usage characteristics of PTT handsets typically require higher capacity batteries and the ability to quickly swap pre-charged batteries into the phone.

These and other requirements are met by the PTT-enabled ruggedized case of the present invention.

2 System Architecture

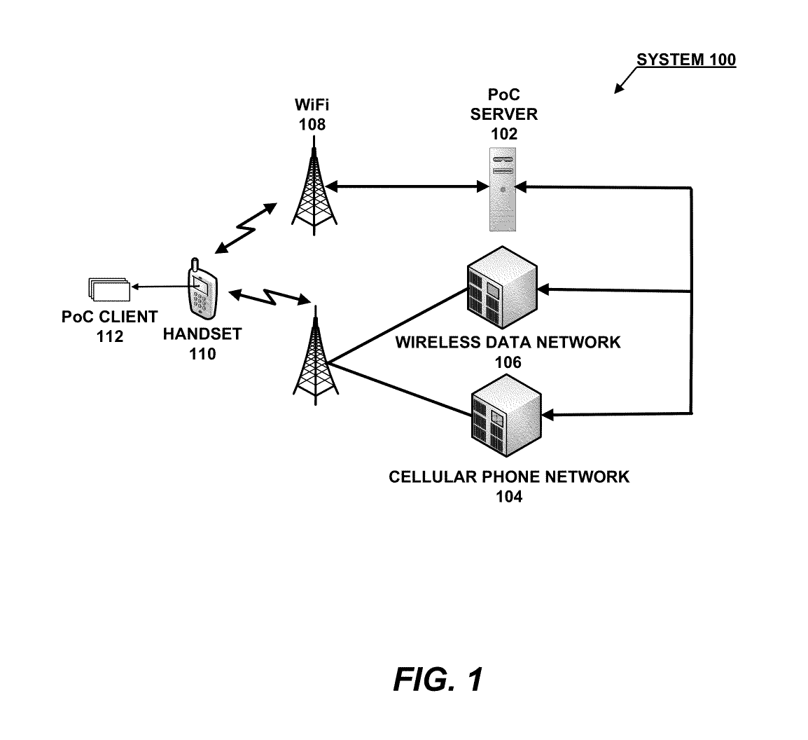

FIG. 1 illustrates one possible system architecture used with the present invention, although other system architectures could be used as well. In this embodiment, the system 100 includes one or more PoC Servers 102, which are connected to one or more wireless communications networks, such as cellular phone networks 104, wireless data networks 106, and WiFi networks 108, in order to communicate with one or more customer handsets 110 executing a PoC Client 112. Additional information on these elements of the system 100, as well as other elements of the system 100, can be found in the cross-referenced applications identified above.

2.1 PoC Server

The PoC Server 102 manages PTT services for the PoC Clients 112. Specifically, the PoC Server 102 acts as an arbitrator for a PTT call session and manages the sending of control and bearer traffic by and between the PoC Clients 112. Additional information on these PTT services, as well as other AVS services and functions, can be found in the cross-referenced applications identified above.

3 Handset

3.1 Handset Components

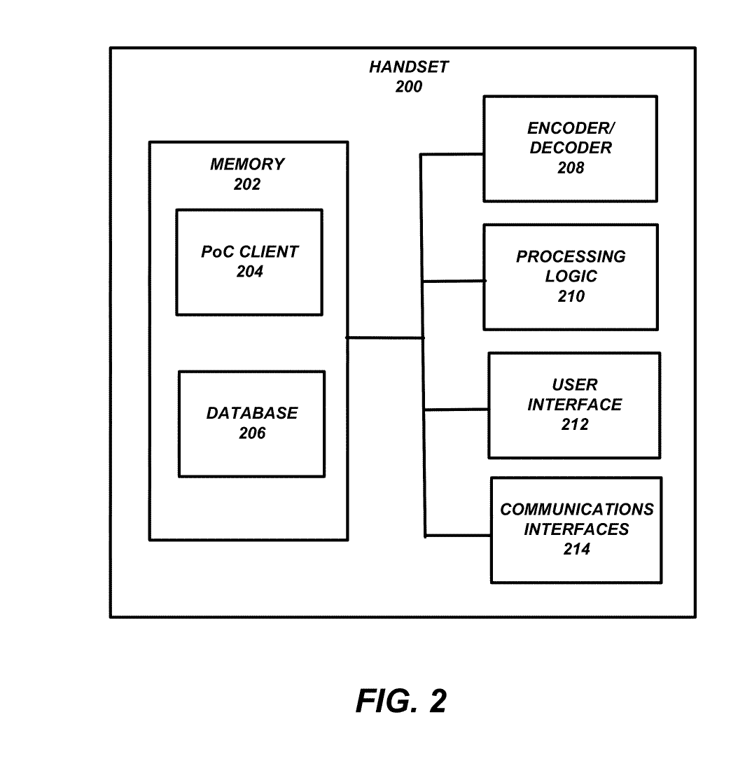

FIG. 2 illustrates the high-level functional components and their interfaces in a handset according to one embodiment of the present invention.

In this embodiment, the handset 200 includes a memory 202 that stores some of the logic and data required of the handset 200 for providing wireless services, including a PoC client 204 and database 206 for supporting PTT related functions such as PTT calling, and Instant Personal Alert. In addition, the database 206 stores contact and group information, and other user information for use by the handset 200.

The high-level functional components of the handset 200 also include an encoder/decoder 208, processing logic 210, user interface 212 and communications interfaces 214.

At power-on, the handset 200 loads the PoC client 204 necessary to support PTT functionality. This functionality provided includes the “look and feel” of the menu displays on the handset 200, as well as user interaction with the menu displays.

During operation, the encoder/decoder 208 decodes and encodes messages, and populates specific data structures in the handset 200. The encoder/decoder 208 checks the validity of the incoming messages by verifying mandatory parameters for each of the incoming messages. A message will not be processed further if the encoder/decoder 208 fails to decode the message.

The processing logic 210 handles all PTT functionality. The processing logic 210 implementation is device-specific and vendor-specific, and it interacts with the other components, including the PoC client 206, database 208, encoder/decoder 208, and user interface 212.

The user interface 212 provides a mechanism for the user to view and manage groups, group members, contacts, presence and availability. The user interface 212 also makes it possible to invoke the PTT features from the group/contact list screens.

The communications interfaces 214 provides a mechanism for the handset 200 to communicate with various wireless networks, as well as input and output devices, such as microphones, speakers, buttons, touchscreens, and the like. The communications interfaces 214 also makes it possible for the handset 200 to communicate with the case or sleeve of the present invention.

3.2 PTT-enabled Ruggedized Case or Sleeve

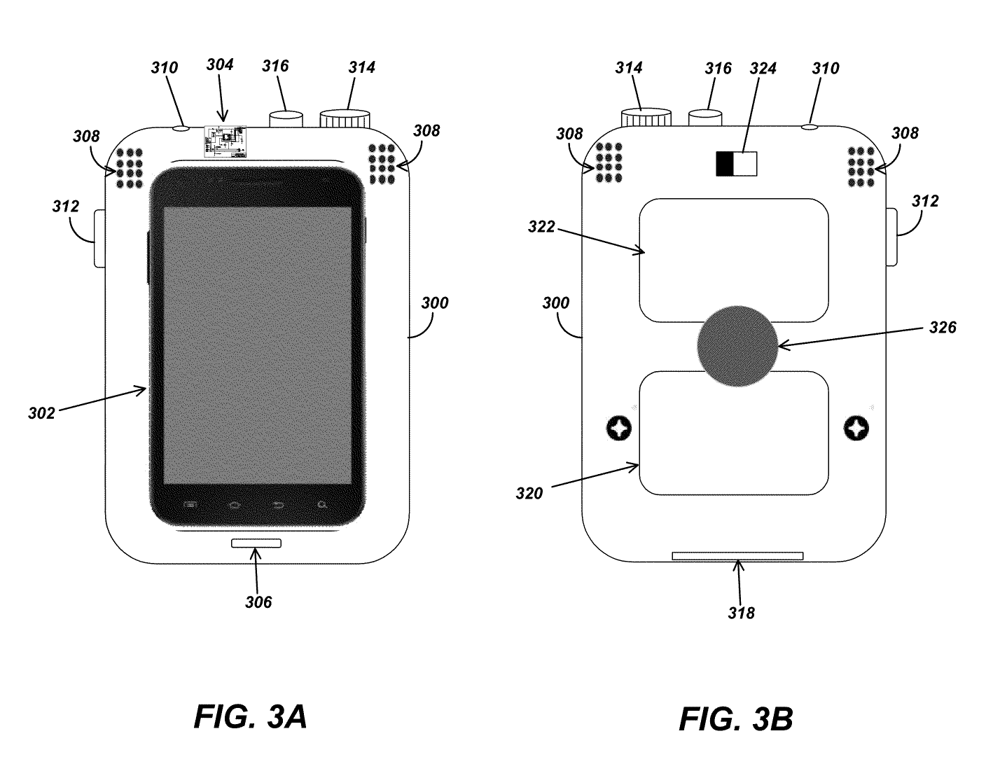

FIG. 3A is a front view of a PTT-enabled ruggedized case, according to a first embodiment of the present invention. Shown in FIG. 3A are the case 300, handset 302, circuitry 304, microphone 306, speakers 308, earphone jack/adapter 310, PTT button 312, thumb-wheel 314 and emergency button 316.

The case 300 is a ruggedized case or sleeve that protects the handset 302 from damage. Specifically, the ruggedized silicone case 300 comes with a screen and grip to keep the handset 302, i.e., a smartphone, safe from dust, liquid and impact.

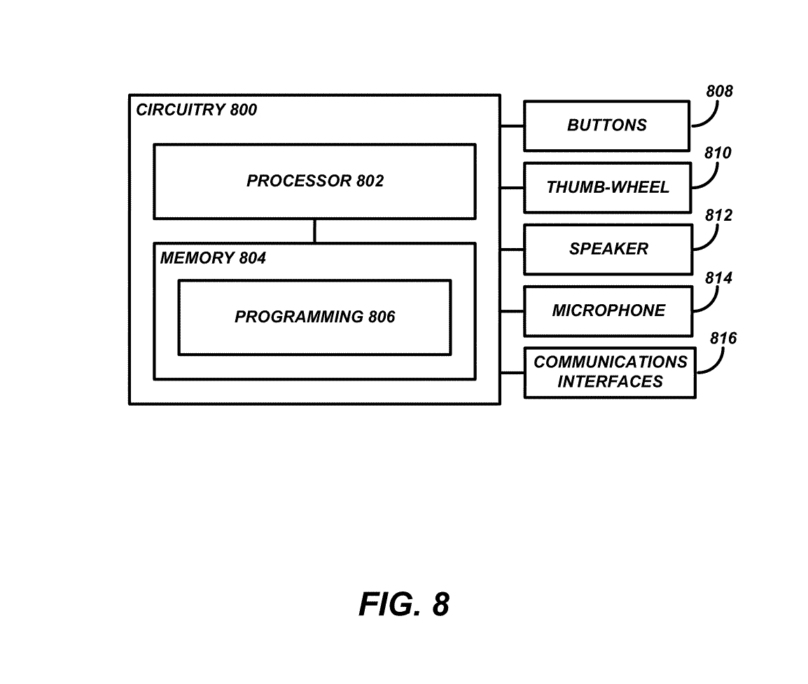

The circuitry 304 is embedded in the case 300 to implement the functions associated with the case 300, as well as communicating with the handset 302. Specifically, the circuitry 304 in the case 300 detects various button 312, 316, or thumb-wheel 314 actions, and transmits signals to the handset 302; in turn, the circuitry 304 receives signals from the handset 302. One possible implementation of this circuitry 304 is described in more detail in FIG. 8 below.

In one embodiment, the case 300 is Bluetooth (BT) enabled, so that there is wireless communication via BT signaling between the case 300 and the handset 302, by means of the circuitry 304 in the case 300. In communicating via BT between the case 300 and the handset 302, additional features are available. For example, Predictive Wakeup (also known as InstaPoC), as described in cross-referenced U.S. Utility application Ser. No. 13/093,542 identified above, may be used to activate both the case 300 and the handset 302. Moreover, a BT sleep mode may also be used, such that, immediately following the end of a call, the case 300 is placed into sleep mode via BT signaling from the handset 302, which will preserve battery life.

The case 300 includes one or more microphones 306 coupled to the handset 302 via the circuitry 304. The microphone 306 inputs sound (e.g., voice) to the circuitry 304, which may be sent to the handset 302.

The case 300 includes one or more speakers 308 coupled to the handset 302 via the circuitry 304. The speakers 308 may be located on the front and/or the rear of the case 300 for outputting sound from the circuitry 304, which may have been received from the handset 302.

The earphone jack/adapter 310 accommodates earphones of various sizes, for outputting sound from the circuitry 304, which may have been received from the handset 302. Alternatively, the case 300 uses Bluetooth to play out the audio received from the handset 302.

The case 300 includes a dedicated PTT button 312 for invoking the PTT functions on the handset 302. The dedicated PTT button 312 activates the circuitry 304 to send an associated signal to the handset 302. The signal may be used for both PTT or Direct Mode Communications functions (e.g. FRS/GMRS/TETRA).

The case 300 includes a thumb-wheel 314 that allows a user to change channels on the handset 302. Specifically, the thumb-wheel 314 activates the circuitry 304 to send an associated signal to the handset 302, wherein the signal may be used to select a channel for the handset 302.

The case 300 includes a dedicated emergency button 316 for signaling one or more recipients via the handset 302 of a distress situation. Specifically, the emergency button 316 activates the circuitry 304 to send an associated signal to the handset 302. The signal may be a “man down” signal for the handset 302.

FIG. 3B is a rear view of the PTT-enabled ruggedized case, according to the first embodiment of the present invention. Shown in FIG. 3B are the case 300, speaker 308, earphone jack/adapter 310, PTT button 312, thumb-wheel 314, emergency button 316, as well as dock connector 318, optional extra battery pack 320, optional Direct Mode Communications module 322, optional switch 324, and optional belt tab 326.

The case 300 includes a dock connector 318 coupled to the handset 302 via the circuitry 304. The dock connector 318 preferably comprises a sturdy, waterproof dock connector 318 that attaches to a cradle (not shown) that, for example, supports charging and possibly provides an external speaker. The dock connector 318, when attached to the cradle, may be used for charging both the battery of the handset 302, as well as the optional extra battery pack 320 that is enclosed within the case 300. The extra battery pack 320 may power the handset 302, as well as the case 300 itself, thereby providing extended battery life for the handset 302.

The case 300 may provide Direct Mode Communications capability (e.g. FRS/GMRS/TETRA) for the handset 302. This is accomplished by the optional Direct Mode Communications module 322, which is coupled to the circuitry 304, to provide Direct Mode Communications functionality for the handset 302. This module 322 may be connected to the microphone 306, speakers 308, PTT button 312, etc., via the circuitry 304.

The optional switch 324, which is coupled to the circuitry 304, allows the user to toggle between the functions of the handset 302 and the optional Direct Mode Communications module 322.

The optional belt tab 326 may be used to attach the case 300 to a universal belt clip (not shown), wherein the case 300 can swivel in the universal belt clip.

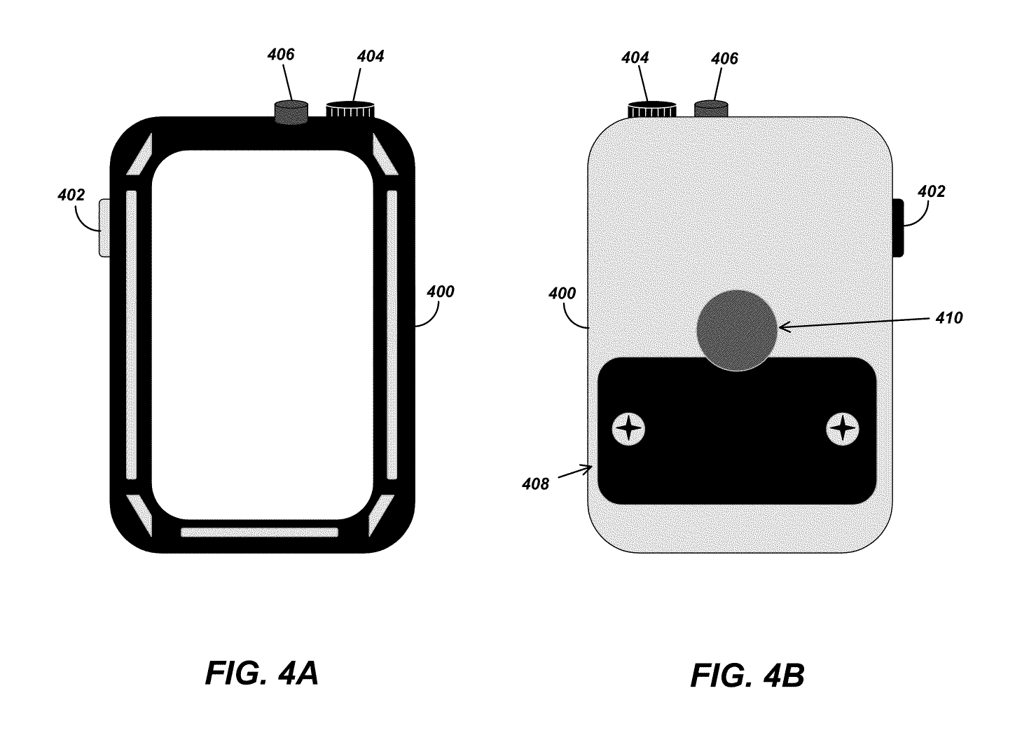

FIGS. 4A and 4B are front and rear views, respectively, of an alternative PTT-enabled ruggedized case, according to a second embodiment of the present invention. Shown in FIG. 4A are the case 400, PTT button 402, thumb-wheel 404, and emergency button 406. Shown in FIG. 4B are the case 400, PTT button 402, thumb-wheel 404, emergency button 406, as well as an optional extra battery pack 408 and optional belt tab 410.

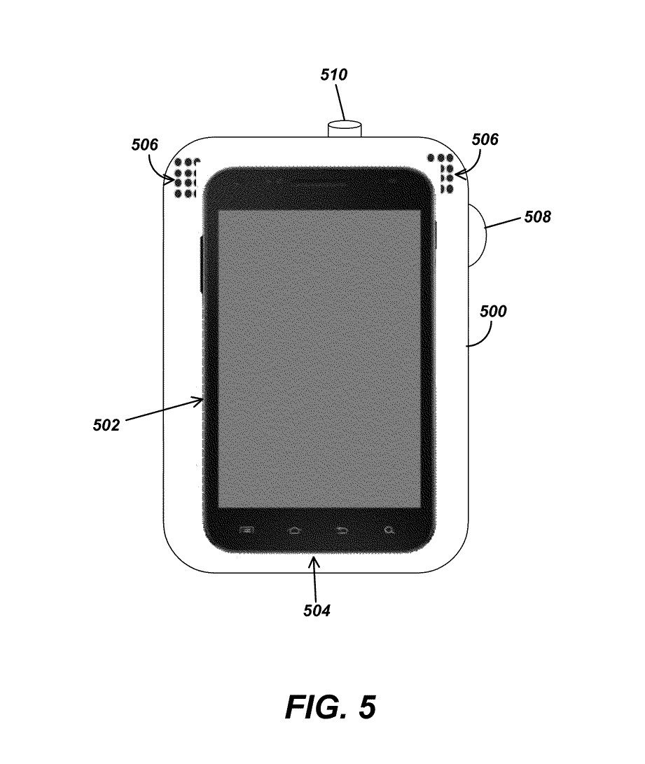

FIG. 5 is a front view of another alternative PTT-enabled ruggedized case, according to a third embodiment of the present invention. Shown in FIG. 5 are the case 500, handset 502, microphone 504, speakers 506, jog-dial 508, and emergency button 510. In this embodiment, the jog-dial 508 performs the functions of both the PTT button and the thumb-wheel.

For example, turning the jog-dial 508 to a numbered setting and then pressing the jog-dial 508 sends a specific BT signal to the handset 502, which, in turn, may initiate a PTT call to a specific contact or group. The numbered setting may either be played out as audio or shown on the display screen of the handset 502. This allows calls to PTT contacts and/or groups to be initiated from a locked screen of the handset 502, without having to unlock the handset 502 to initiate the call.

In another example, the jog-dial 508 may perform a volume control function. Turning and/or pressing the jog-dial 508 may increase or decrease the volume of the speakers 506 in the case 500.

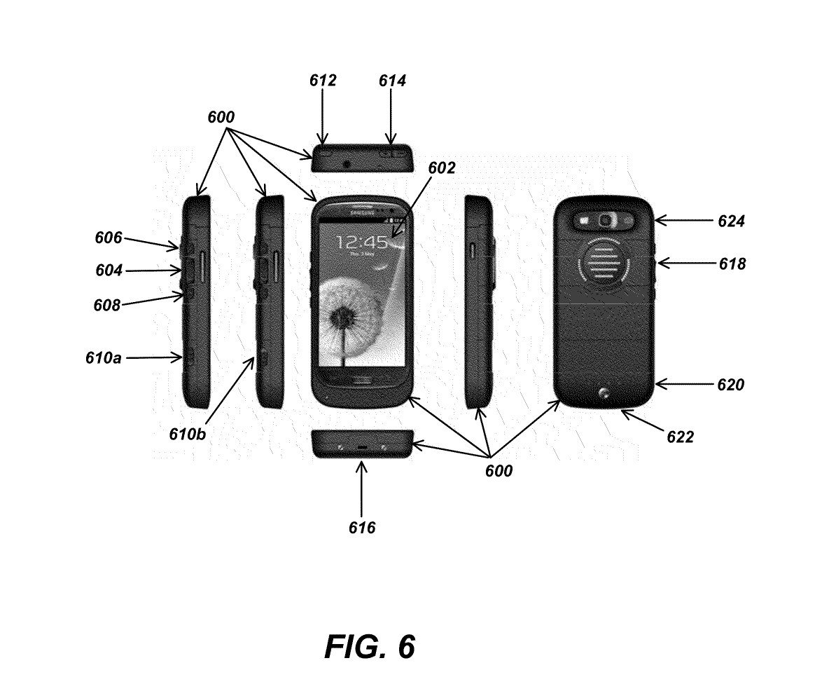

FIG. 6 shows various views of an alternative PTT-enabled ruggedized case, according to a fourth embodiment of the present invention. Shown in FIG. 6 are a case 600 and handset 602, wherein the different views of the case 600 include from left to right in the figure comprise the right (twice), front (including the handset 602), top, bottom, left and back sides of the case 600. Shown in the right side views of the case 600 are a PTT button 604, scroll down 606, and scroll up 608. Also shown on the right sides of the case 600 is a Bluetooth on/off switch 610, wherein 610a shows the switch 610 in an “on” position, while 610b shows the switch 610 in an “off” position. Shown in the top view of the case 600 are an emergency button 612 and volume up/down control 614. Shown in the bottom view of the case 600 is a dock connector 616 (e.g., a Micro USB port). Shown in the back side view of the case 600 is a speaker 618 (i.e., the circular feature in the middle of the back side of the case 600), and four LEDs 620 indicating battery status. Also shown on the back side of the case 600 is a button 622, which, when pressed, causes the four LEDs 620 to display the status of the battery on the case 600, i.e., its charge level. Finally, a (somewhat) elliptical feature 624 at the top of the back side of the case 600 is an aperture through the case 600 for the camera in the handset 602.

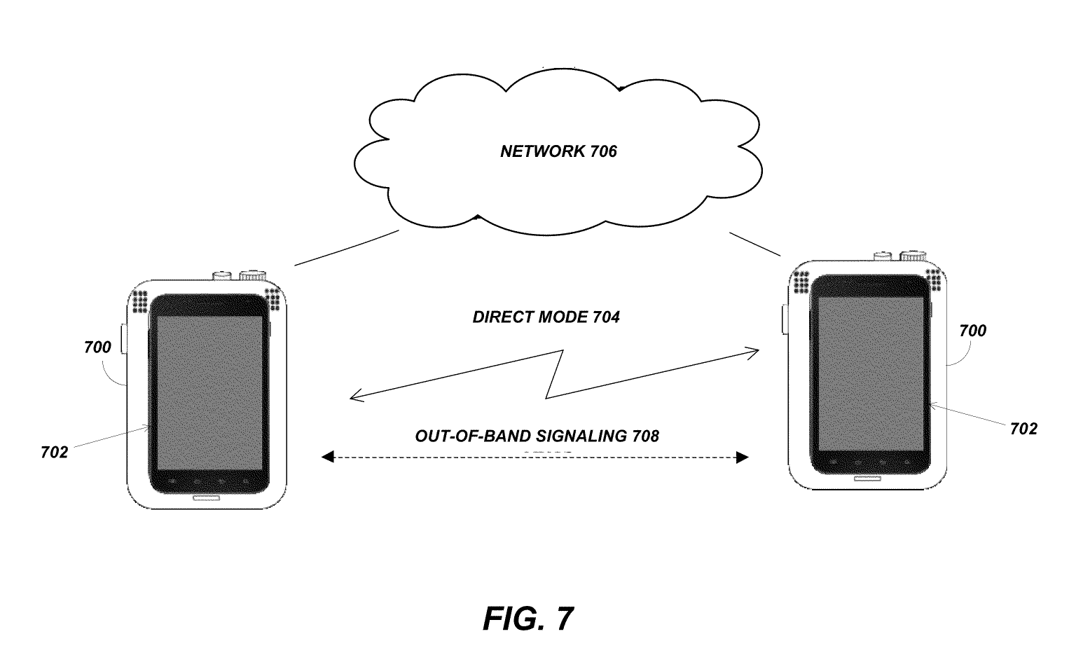

FIG. 7 illustrates how a PTT-enabled ruggedized case may facilitate Direct Mode Communications. In this example, two or more PTT-enabled ruggedized cases 700 enclosing and communicating with their respective handsets 702 communicate with each other in Direct Mode via, for example, FRS/GMRS/TETRA protocols 704, rather than through the network 706 infrastructure. Such Direct Mode Communications via, for example, FRS/GMRS/TETRA protocols 704, may also be used for exchanging out-of-band signaling information 708 between the ruggedized cases 700 and their handsets 702.

FIG. 8 illustrates an exemplary schematic of the circuitry embedded in a PTT-enabled ruggedized case as shown in FIGS. 3A and 3B above. The exemplary schematic 800 includes a processor 802 as well as memory 804 storing programming 806 executed by the processor 802 to provide the various functionality of the PTT-enabled ruggedized case described herein. The processor 802 may be coupled to other devices, including input/output (I/O) devices, such as buttons 808, thumb-wheel 810, speakers 812, microphone 814, and one or more communications interfaces 816, such as a BT interface or other interface with the handset. Of course, the circuitry may be implemented in other ways, such as application-specific circuitry.

### CONCLUSION

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. An apparatus for providing advanced voice services (AVS) in a wireless network, comprising:
a case or sleeve for enclosing a handset, wherein the case or sleeve communicates with the handset to provide or support Push-to-Talk (PTT) functions on the handset, thereby converting the handset into a PTT-enabled handset, without requiring any hardware changes to the handset.

2. The apparatus of claim 1, wherein the case or sleeve includes a dedicated PTT button for invoking the PTT functions on the handset.

3. The apparatus of claim 1, wherein the case or sleeve is a ruggedized case or sleeve that protects the handset from damage.

4. The apparatus of claim 1, wherein the case or sleeve includes a dedicated emergency button for signaling one or more recipients via the handset of a distress situation.

5. The apparatus of claim 1, wherein the case or sleeve includes one or more microphones coupled to the handset.

6. The apparatus of claim 1, wherein the case or sleeve includes one or more speakers coupled to the handset.

7. The apparatus of claim 1, wherein the case or sleeve includes a dock connector coupled to the handset.

8. The apparatus of claim 1, wherein the case or sleeve provides Direct Mode Communications capability for the handset.

9. The apparatus of claim 8, wherein, when the handset detects that it is of out-of-coverage, the handset automatically switches to the Direct Mode Communications capability provided by the case or sleeve.

10. The apparatus of claim 1, wherein the case or sleeve includes a thumb-wheel that allows a user to change channels on the handset.

11. The apparatus of claim 1, wherein the case or sleeve includes a battery for powering the handset.

12. The apparatus of claim 1, wherein the case or sleeve includes a battery for powering the case or sleeve.

13. A method of providing advanced voice services (AVS) in a wireless network, comprising:
providing a case or sleeve for enclosing a handset, wherein the case or sleeve communicates with the handset to provide or support Push-to-Talk (PTT) functions on the handset, thereby converting the handset into a PTT-enabled handset, without requiring any hardware changes to the handset.

14. The method of claim 13, wherein the case or sleeve includes a dedicated PTT button for invoking the PTT functions on the handset.

15. The method of claim 13, wherein the case or sleeve is a ruggedized case or sleeve that protects the handset from damage.

16. The method of claim 13, wherein the case or sleeve includes a dedicated emergency button for signaling one or more recipients via the handset of a distress situation.

17. The method of claim 13, wherein the case or sleeve includes one or more microphones coupled to the handset.

18. The method of claim 13, wherein the case or sleeve includes one or more speakers coupled to the handset.

19. The method of claim 13, wherein the case or sleeve includes a dock connector coupled to the handset.

20. The method of claim 13, wherein the case or sleeve provides Direct Mode Communications capability for the handset.

21. The method of claim 20, wherein, when the handset detects that it is of out-of-coverage, the handset automatically switches to the Direct Mode Communications capability provided by the case or sleeve.

22. The method of claim 13, wherein the case or sleeve includes a thumb-wheel that allows a user to change channels on the handset.

23. The method of claim 13, wherein the case or sleeve includes a battery for powering the handset.

24. The method of claim 13, wherein the case or sleeve includes a battery for powering the case or sleeve.
